(19) United States
(12) Patent Application Publication
(10) Pub. No.: US 2024/0325994 A1
(43) Pub. Date: Oct. 3, 2024

(54) AERATION SUPPRESSOR FOR HIGH-SHEAR MIXER

(71) Applicant: XEROX CORPORATION, NORWALK, CT (US)

(72) Inventors: Lanhui Zhang, Webster, NY (US); Genggeng Qi, Webster, NY (US); Brian J. Marion, Ontario, NY (US); Troy Brown, Geneseo, NY (US); Yu Qi, Penfield, NY (US); Chieh-Min Cheng, Rochester, NY (US)

(73) Assignee: XEROX CORPORATION, NORWALK, CT (US)

(21) Appl. No.: 18/191,951

(22) Filed: Mar. 29, 2023

(51) Int. Cl. B01F 23/43; B01F 23/40

(52) U.S. Cl. CPC B01F 23/43; B01F 23/405

(57) ABSTRACT

A mixer includes a shaft and an agitator coupled to the shaft. The shaft and the agitator are configured to rotate together to mix a liquid composition. The mixer also includes a sleeve positioned around the shaft. The sleeve forms a gap between the shaft and the sleeve. The sleeve is positioned in the liquid composition such that the liquid composition fills the gap up to the surface of the liquid composition in the gap to form a liquid seal between the shaft and the sleeve that minimizes an amount of air that penetrates into the liquid composition outside the gap during rotation of the shaft and the agitator.

### TECHNICAL FIELD

The present teachings relate generally to mixing compositions and, more particularly, to systems and methods for suppressing aeration while mixing liquid compositions.

### BACKGROUND

A high-shear mixer disperses, or transports, one phase or ingredient (e.g., liquid, solid, and/or gas) into a main continuous phase (e.g., liquid), with which it could be immiscible or miscible. An agitator, together with a stationary component known as a stator, or an array of rotors and stators, is used either in a tank containing the composition to be mixed, or in a pipe through which the composition passes, to create shear. The high-shear mixer can be used to create compositions such as emulsions, suspensions, lyosols (e.g., gas dispersed in liquid), and/or granular products. It is used in the adhesives, chemical, cosmetic, food, pharmaceutical, and plastics industries for emulsification, homogenization, particle size reduction, and dispersion.

However, high-shear mixing usually accompanies aeration, which introduces air into the (e.g., liquid) composition and causes foaming and/or the formation of micro-bubbles. The foaming may impact the efficiency and effectiveness not only of the high-shear mixing itself but also the subsequent process (e.g., milling).

In one example, a pre-milling process may be performed for a pigment dispersion preparation/production. The pre-milling process applies high shear to the pigment/dispersant composition to break up large aggregates into smaller ones. In the lab scale, this pre-milling process is usually carried out in a high-shear mixer. Because the mixture includes a lot of surfactants, quite often, such a process accompanies severe foaming and/or micro bubble formation, unless sufficient effective defoamer is introduced. Foam and micro bubbles not only reduce the dispersion efficiency and effectiveness but also the dispersion stability in the subsequent milling process because they consume a significant portion of the dispersant.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A mixer is disclosed. The mixer includes a shaft and an agitator coupled to the shaft. The shaft and the agitator are configured to rotate together to mix a liquid composition. The mixer also includes a sleeve positioned around the shaft. The sleeve forms a gap between the shaft and the sleeve. The sleeve is positioned in the liquid composition such that the liquid composition fills the gap up to the surface of the liquid composition in the gap to form a liquid seal between the shaft and the sleeve that minimizes an amount of air that penetrates into the liquid composition outside the gap during rotation of the shaft and the agitator.

A high-shear mixer is also disclosed. The mixer includes a shaft and an agitator coupled to a lower end of the shaft. The shaft and the agitator are configured to rotate together to mix a liquid composition. The liquid composition includes water, a surfactant, and aggregates of particles. Mixing the liquid composition breaks the aggregates into smaller sizes. The mixer also includes a shield positioned around the shaft. The shield does not rotate together with the shaft and the agitator. A first annulus is formed between the shaft and the shield. A width of the first annulus is from about 3 mm to about 50 mm. The mixer also includes a sleeve positioned at least partially within the first annulus. The sleeve is coupled to an inner surface of the shield. The sleeve does not rotate together with the shaft and the agitator. A lower portion of the sleeve is configured to be positioned below a surface of the liquid composition while mixing. An upper portion the sleeve is configured to be positioned above the surface of the liquid composition while mixing. A second annulus is formed between the shaft and the sleeve. A width of the second annulus is from about 20 μm to about 3 mm. The liquid composition fills at least a portion of the first annulus and the second annulus to form a liquid seal between the shaft and the sleeve that minimizes an amount of air that penetrates downward through the second annulus and into the liquid composition outside the second annulus and the first annulus during rotation of the shaft and the agitator, which reduces both an amount of foam in the liquid composition and an amount that a volume of the liquid composition increases while mixing.

A method for mixing a liquid composition is also disclosed. The method includes positioning a mixer into the liquid composition. The mixer includes a shaft, an agitator, and a sleeve. The agitator is coupled to the shaft. The shaft and the agitator are configured to rotate together. The sleeve is positioned around the shaft forming a gap between the shaft and the sleeve. The sleeve is positioned in the liquid composition such that the liquid composition fills the gap up to the surface of the liquid composition in the gap to form a liquid seal between the shaft and the sleeve. The method also includes mixing the liquid composition. Foaming of the liquid composition is reduced due to the liquid seal that minimizes an amount of air that penetrates into the liquid composition outside the gap during rotation of the shaft and the agitator.

In another embodiment, the method includes positioning a mixer into the liquid composition. The mixer comprises a shaft, a sleeve around the shaft, an agitator, and a shield around the sleeve. The sleeve and the shaft are coupled together or the sleeve incorporates the shaft into a single-piece sleeve/shaft. The agitator is configured to rotate with the shaft coupled to the sleeve or the single-piece sleeve/shaft. There is a gap between the shield and the sleeve coupled to the shaft or the single-piece sleeve/shaft. The mixer is positioned such that the liquid composition fills the gap up to the surface of the liquid composition in the gap to form a liquid seal between the shield and the sleeve coupled to the shaft or the single-piece sleeve/shaft. The method also includes mixing the liquid composition. Foaming of the liquid composition is reduced due to the liquid seal that minimizes an amount of air that penetrates into the liquid composition outside the gap during the mixing.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1A depicts a cross-sectional side view of a mixer, according to a prior art embodiment.

FIG. 1B depicts a perspective view of the mixer of FIG. 1A mixing a liquid composition, according to a prior art embodiment.

FIG. 2A depicts a cross-sectional side view of the mixer including a sleeve, according to an embodiment.

FIG. 2B depicts a perspective view of the mixer of FIG. 2A mixing the liquid composition, according to an embodiment.

FIG. 3 depicts a flowchart of a method for mixing the liquid composition, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

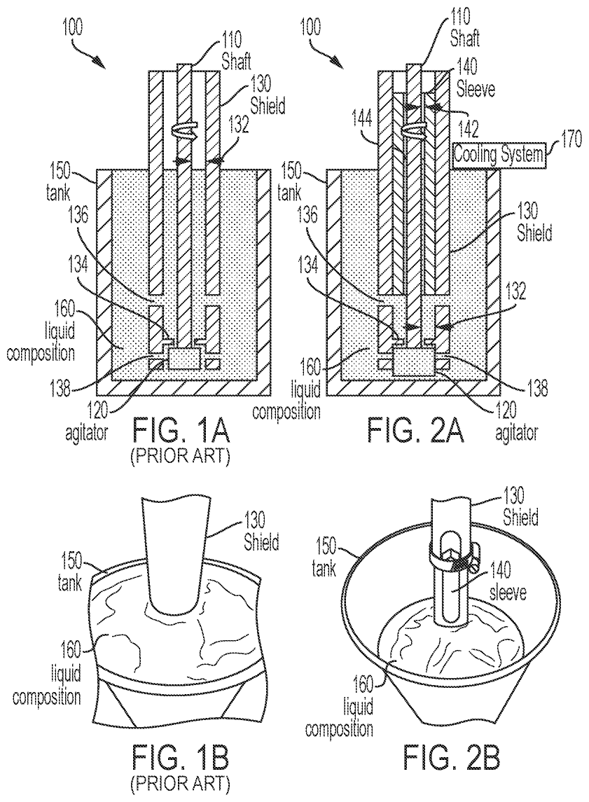

FIG. 1A depicts a cross-sectional side view of a mixer 100, according to an embodiment. The mixer 100 may be or include a high-shear mixer. The mixer 100 may include a shaft 110 that is configured to rotate about a (e.g., vertical) central longitudinal axis. In an example, the shaft 110 may rotate at a rate from about 100 rotations per minute (RPM) to about 500 RPM, about 500 RPM to about 1,000 RPM, about 1,000 RPM to about 5,000 RPM, or about 5,000 RPM to about 10,000 RPM.

The mixer 100 may also include an agitator 120 that is coupled to or integral with the shaft 110. The agitator 120 may be or include a blade, a rotor, an impeller, or the like that is configured to rotate together with the shaft 110 to mix a (e.g., liquid) composition 160. The composition may also be referred to as a mixture or solution.

The mixer 100 may also include a shield 130 that is positioned around the shaft 110 and/or the agitator 120. The shield 130 may not rotate together with the shaft 110 and/or the agitator 120. The shield 130 creates a close-clearance space between the shaft 110 and/or the agitator 120 and itself and forms an extremely high-shear zone for the composition 160 as it exits the shaft 110 and/or the agitator 120.

As shown, the shaft 110 and the shield 130 may be concentric with one another. A space 132 may be formed between the shaft 110 and the shield 130. The space 132 may be an annulus. The space 132 may have a width from about 2 mm, about 3 mm, about 4 mm, or about 5 mm to about 10 mm, about 20 mm about 50 mm, or about 100 mm, where any lower end of the range may be paired with any upper end of the range. In one embodiment, the shield 130 may be omitted.

The shield 130 may include a bearing 134 that extends (e.g., radially-inward) therefrom toward the shaft 110. The bearing 134 may be positioned (e.g., directly) above a portion of the agitator 120. The lower portion of the shield 130 that is positioned around (e.g., laterally to the side of and/or above) the agitator 120 may serve to hold the shaft 110 in place. It may also or instead connect to and support a stator (e.g., via screws). The shield 130 may also include one or more first openings 136 (e.g., radially-through) the shield 130 that allow the composition 160 in the space 132 between the shaft 110 and the shield 130 to mix with the rest of the composition in a tank 160. The shield 130 may also include one or more second openings 138 (e.g., radially-through) the shield 130 that help to create high-shear during mixing. As shown, the first opening(s) 136 may be above the agitator 120 and/or the bearing 134, and the second opening(s) 138 may be below the agitator 120 and/or the bearing 134. The second openings 138 may be slits, round holes, square holes, rectangular holes, or the like.

The mixer 100 may be configured to be positioned at least partially within the tank 150. More particularly, the shaft 110, the agitator 120, and/or the shield 130 may be positioned at least partially into the composition 160 in the tank 150. The composition 160 may be or include an emulsion, a suspension, a lyosol (e.g., gas dispersed in liquid), a granular product, or a combination thereof. For example, the composition may be or include a liquid composition including water, surfactant, aggregates of particles, pigment, or a combination thereof. In one specific example, the liquid composition 160 may be or include a pigment dispersion.

FIG. 1B depicts a perspective view of the mixer 100 of FIG. 1A mixing the liquid composition 160, according to an embodiment. The shaft 110 and the agitator 120 may be configured to rotate to mix the composition 160. The rotation may cause a vortex to form in the space 132. The vortex may drag air downward through the space 132 and cause the air to be introduced into the composition 160. More particularly, the air may be dispersed in the composition 160 and cause foaming and/or micro-bubbles therein. The foaming and/or micro-bubbles may start from the surface area where the shaft 110 contacts the composition 160.

In the specific example in FIG. 1B, the mixing may be part of a pre-milling process, and the composition 160 includes water, dispersion, and pigment (e.g., magenta). The mixer 100 mixes the composition 160 at 4000 RPM for about 10 minutes. A large amount of air is dispersed into the liquid composition 160 and forms severe foam and/or micro bubbles. This increases the volume of the liquid composition 160.

FIG. 2A depicts a cross-sectional side view of the mixer 100 including a sleeve 140, according to an embodiment. The mixer 100 in FIG. 2A may be similar to the mixer 100 in FIG. 1A, except the mixer 100 in FIG. 2A may also include the sleeve 140. The sleeve 140 may be made of a metal or a polymer. In one example, the sleeve 140 may be made of polytetrafluoroethylene (PTFE).

The sleeve 140 may be positioned in the space 132 between the shaft 110 and the shield 130. In one embodiment, the sleeve 140 may be coupled to (e.g., an inner surface of) the shield 130 and extend (e.g., radially-) inward toward the shaft 110. In this embodiment, the shield 130 and the sleeve 140 may not rotate together with the shaft 110 and the agitator 120. In another embodiment, the shield 130 may be omitted, and the sleeve 140 may be held spaced apart (e.g., radially-outward from) the shaft 110 by a support structure. The support structure may be or include one or more arms that are substantially horizontal. For example, the support structure may include two or more arms that are circumferentially-offset from one another around the sleeve 140. In this embodiment, the sleeve 140 and the support structure may not rotate together with the shaft 110 and the agitator 120. In yet another embodiment, the sleeve 140 may be coupled to (e.g., an outer surface of) the shaft 110 and extend (e.g., radially-) outward toward the shield 130. In this embodiment, the sleeve 140 may rotate together with the shaft 110 and the agitator 120.

As shown, the shaft 110, the shield 130, the sleeve 140, or a combination thereof may be concentric with one another. A gap 142 may be formed between the shaft 110 and the sleeve 140 (e.g., when the sleeve 140 is coupled to the shield 130). In another embodiment, the gap 142 may be formed between the shield 130 and the sleeve 140 (e.g., when the sleeve 140 is coupled to the shaft 110). The gap 142 may be an annulus. The gap 142 may have a width from about 10 μm, about 20 μm, about 50 μm, or about 100 μm to about 500 μm, about 1 mm about 2 mm, or about 3 mm, where any lower end of the range may be paired with any upper end of the range. The gap 142 may allow the shaft 110 to rotate without contacting the sleeve 140. The space 132 between the shaft 110 and the shield 130 may be present above and/or below the sleeve 140.

A lower end of the sleeve 140 may be positioned above lower end(s) of the shaft 110 and/or the shield 130, and an upper end of the sleeve 140 may be positioned below upper end(s) of the shaft 110 and/or the shield 130. The mixer 100 may be positioned with the tank 150 and/or composition 160 such that a lower portion of the sleeve 140 is positioned within the tank 150 and/or composition 160, and an upper portion of the sleeve 140 is positioned outside of (e.g., above) the tank 150 and/or composition 160. In the embodiment shown, the first opening(s) 136 may be positioned below the sleeve 140. The first opening(s) 136 may be a hole or long opening having any height.

In one embodiment, the mixer 100 may include a cooling system 170. The cooling system 170 may be or include a cooling jacket that is configured to be positioned around the shield 130, the tank 150, or both. The cooling system 170 may be configured to cool (e.g., reduce the temperature of) one or more parts of the mixer 100 and/or the liquid composition 160. This may allow the high-shear mixing pre-milling process to be carried out for an unlimited time period while minimizing the amount of air that is introduced into the composition 160, the amount of foaming and/or micro-bubbles generated in the composition 160, the amount that a volume of the composition 160 increases, or a combination thereof.

FIG. 2B depicts a perspective view of the mixer 100 of FIG. 2A mixing the liquid composition 160, according to an embodiment. A portion of the shield 130 is omitted in FIG. 2A to show the sleeve 140 therein. The sleeve 140 (and the smaller gap 142 created by the sleeve 140) may minimize (also referred to as reduce or suppress) the aeration introduced into the composition 160 during the (e.g., high-shear) mixing process. Some composition 160 may flow up and into the gap 142 to form a liquid seal 144 (see FIG. 2A) that minimizes an amount and/or rate of air that penetrates (e.g., downward) into the composition 160. More particularly, the liquid composition in the gap 142 forms the liquid seal 144 between air above the liquid seal 144 and the bulk liquid composition 160, that is, the liquid composition 160 outside the gap 142. The liquid seal 144 may be a partial or total barrier to air entering the bulk liquid composition 160 during mixing. Thus, the sleeve 140, the gap 142, and/or the liquid seal 144 may reduce the amount of air that is introduced into the composition 160, the amount of foaming and/or micro-bubbles generated in the composition 160, the amount that the volume of the composition 160 increases, or a combination thereof.

In one example, the sleeve 140, the gap 142, and/or the liquid seal 144 may reduce the amount of air that is introduced into the composition 160, the amount of foaming and/or micro-bubbles generated in the composition 160, the amount that the volume of the composition 160 increases, or a combination thereof by 50% or more, 60% or more, 70% or more, 80% or more, or 90% or more (e.g., in comparison to the embodiment in FIG. 1A). In another example, the sleeve 140, the gap 142, and/or the liquid seal 144 may cause the volume of the composition 160 to increase by less than 20%, less than 10%, or less than 5% after being mixed at 4000 RPM, 6000 RPM, or 8000 RPM for 5 minutes, 10 minutes, or 30 minutes. FIG. 2B illustrates a specific example in which the mixer 100 mixes the (e.g., liquid) composition 160 at 8000 RPM for about 30 minutes, and the volume of the liquid composition 160 remains lower than in FIG. 1B.

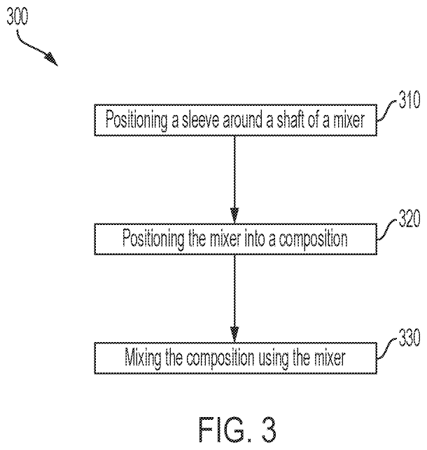

FIG. 3 depicts a flowchart of a method 300 for mixing the (e.g., liquid) composition 160, according to an embodiment. The method 300 may be performed using the mixer 100 in FIG. 2A (e.g., with the sleeve 140). An illustrative order of the method 300 is provided below; however, one or more steps of the method 300 may be performed in a different order, performed simultaneously, repeated, or omitted.

The method 300 may include positioning the sleeve 140 around the shaft 110, as at 310. As described above, this may include coupling the sleeve 140 to the inner surface of the shield 130. In another example, the sleeve 140 may instead incorporate the shield 130 into a single-piece sleeve/shield with no space or gap therebetween. In yet another example, the sleeve 140 may be coupled to the outer surface of the shaft 110. In yet another example, the sleeve 140 may incorporate the shaft 110 into a single-piece sleeve/shaft with no space or gap therebetween. Rather, in this example, the gap may instead be between the shield 130 and the sleeve 140. As described above, the sleeve 140 may reduce the cross-sectional area (e.g., the annulus) between the shaft 110 and the shield 130.

The method 300 may also include positioning the mixer 100 into the composition 160, as at 320. The sleeve 140 may be positioned in the composition 160 such that the composition 160 fills the gap 142 up to the surface of the composition 160 in the gap 142 to form the (e.g., liquid) seal 144 between the shaft 110 and the sleeve 140.

The method 300 may also include mixing the composition 160 (e.g., using the mixer 100), as at 330. Foaming of the composition 160 may be reduced due to the liquid seal 144 that minimizes an amount of air that penetrates into the composition 160 outside the gap 142 during rotation of the shaft 110 and the agitator 130.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including.” “includes,” “having.” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A mixer, comprising:
a shaft;
an agitator coupled to the shaft, wherein the shaft and the agitator are configured to rotate together to mix a liquid composition; and
a sleeve positioned around the shaft forming a gap between the shaft and the sleeve, wherein the sleeve is positioned in the liquid composition such that the liquid composition fills the gap up to the surface of the liquid composition in the gap to form a liquid seal between the shaft and the sleeve that minimizes an amount of air that penetrates into the liquid composition outside the gap during rotation of the shaft and the agitator.

2. The mixer of claim 1, wherein the gap between the shaft and the sleeve has a width from about 20 μm to about 3 mm.

3. The mixer of claim 1, wherein the gap between the shaft and the sleeve comprises an annulus.

4. The mixer of claim 1, wherein the sleeve is positioned above and below the surface of the liquid composition.

5. The mixer of claim 1, wherein the liquid seal reduces both an amount of foam created in the liquid composition during mixing and an amount that a volume of the liquid composition increases during mixing.

6. The mixer of claim 1, further comprising a shield positioned around the shaft and the sleeve, wherein a space between the shaft and the shield has a width from about 3 mm to about 50 mm.

7. The mixer of claim 5, wherein the sleeve is coupled to an inner surface of the shield, and wherein the shield and the sleeve do not rotate together with the shaft and the agitator.

8. The mixer of claim 5, wherein the sleeve incorporates the shield into a single-piece sleeve/shield, and wherein the sleeve/shield does not rotate together with the shaft and the agitator.

9. The mixer of claim 5, wherein the sleeve is positioned within the space between the shaft and the shield, and wherein the sleeve extends radially-inward from the shield toward the shaft.

10. The mixer of claim 5, wherein the space between the shaft and the shield is present both above and below the sleeve.

11. A high-shear mixer, comprising:
a shaft;
an agitator coupled to a lower end of the shaft, wherein the shaft and the agitator are configured to rotate together to mix a liquid composition, wherein the liquid composition comprises water, a surfactant, and aggregates of particles, and wherein mixing the liquid composition breaks the aggregates into smaller sizes;
a shield positioned around the shaft, wherein the shield does not rotate together with the shaft and the agitator, wherein a first annulus is formed between the shaft and the shield, and wherein a width of the first annulus is from about 3 mm to about 50 mm; and
a sleeve positioned at least partially within the first annulus, wherein the sleeve is coupled to an inner surface of the shield, wherein the sleeve does not rotate together with the shaft and the agitator, wherein a lower portion of the sleeve is configured to be positioned below a surface of the liquid composition while mixing, wherein an upper portion the sleeve is configured to be positioned above the surface of the liquid composition while mixing, wherein a second annulus is formed between the shaft and the sleeve, wherein a width of the second annulus is from about 20 μm to about 3 mm, wherein the liquid composition fills at least a portion of the first annulus and the second annulus to form a liquid seal between the shaft and the sleeve that minimizes an amount of air that penetrates downward through the second annulus and into the liquid composition outside the second annulus and the first annulus during rotation of the shaft and the agitator, which reduces both an amount of foam in the liquid composition and an amount that a volume of the liquid composition increases while mixing.

12. The mixer of claim 11, wherein a lower end of the sleeve is positioned above lower ends of the shaft and the shield, and wherein an upper end of the sleeve is positioned below upper ends of the shaft and the shield.

13. The mixer of claim 11, wherein the agitator comprises an impeller, a rotor, or a blade.

14. The mixer of claim 11, wherein the sleeve comprises polytetrafluoroethylene (PTFE).

15. A method for mixing a liquid composition, the method comprising:
(a) positioning a mixer into the liquid composition, wherein the mixer comprises a shaft, an agitator, and a sleeve, wherein the agitator is coupled to the shaft, wherein the shaft and the agitator are configured to rotate together, wherein the sleeve is positioned around the shaft forming a gap between the shaft and the sleeve, where the sleeve is positioned in the liquid composition such that the liquid composition fills the gap up to the surface of the liquid composition in the gap to form a liquid seal between the shaft and the sleeve; and
(b) mixing the liquid composition, wherein foaming of the liquid composition is reduced due to the liquid seal that minimizes an amount of air that penetrates into the liquid composition outside the gap during rotation of the shaft and the agitator.

16. The method of claim 15, wherein a shield is positioned around the shaft and the sleeve, wherein the sleeve is coupled to an inner surface of the shield, and wherein the sleeve and the shield do not rotate together with the shaft and the agitator.

17. The method of claim 15, wherein the mixer is positioned such that the sleeve is positioned above and below the surface of the liquid composition.

18. The method of claim 15, wherein the sleeve reduces the amount of air that penetrates into the liquid composition by 50% or more during the mixing.

19. The method of claim 15, wherein the sleeve causes a volume of the liquid composition to increase by less than 10% after being mixed by the agitator at 6000 rotations per minute (RPM) for 10 minutes.

20. A method for mixing a liquid composition, the method comprising:
(a) positioning a mixer into the liquid composition, wherein the mixer comprises a shaft, a sleeve around the shaft, an agitator, and a shield around the sleeve, wherein the sleeve and the shaft are coupled together or the sleeve incorporates the shaft into a single-piece sleeve/shaft, wherein the agitator is configured to rotate with the shaft coupled to the sleeve or the single-piece sleeve/shaft, wherein there is a gap between the shield and the sleeve coupled to the shaft or the single-piece sleeve/shaft, wherein the mixer is positioned such that the liquid composition fills the gap up to the surface of the liquid composition in the gap to form a liquid seal between the shield and the sleeve coupled to the shaft or the single-piece sleeve/shaft; and
(b) mixing the liquid composition, wherein foaming of the liquid composition is reduced due to the liquid seal that minimizes an amount of air that penetrates into the liquid composition outside the gap during the mixing.
